(19) United States
(12) Patent Application Publication
(10) Pub. No.: US 2012/0222998 A1
(43) Pub. Date: Sep. 6, 2012

(54) SELF-CLEANING RAIN DOWNSPOUT FILTRATION DEVICE

(76) Inventor: KENNETH D. PIERZCHALSKI, Lubbock, TX (US)

(21) Appl. No.: 13/407,963

(22) Filed: Feb. 29, 2012

Related U.S. Application Data
(60) Provisional application No. 61/447,794, filed on Mar. 1, 2011.

(51) Int. Cl. C02F 1/00

(52) U.S. Cl. 210/170.03

(57) ABSTRACT

A rain water filtration device, the device having a plurality of vertically stacked chambers, each chamber in staggered succession and each chamber in fluid communication with at least one other chamber through a debris screen, the topmost chamber further having a receiving end in fluid communication with a rain gutter and the bottom most chamber further having an exit end capable of fluidly communicating with a storage tank.

### CROSS REFERENCE TO RELATED APPLICATIONS

This application claims the benefit of provisional application 61/447,794 filed Mar. 1, 2011 by the present inventor and the same is incorporated hereto in its entirety.

### STATEMENT REGARDING FEDERALLY SPONSORED RESEARCH OR DEVELOPMENT

Not Applicable

### NAMES OF PARTIES TO JOINT RESEARCH AGREEMENT

Not Applicable

### REFERENCE TO SEQUENCE LISTING

Not Applicable

### DESCRIPTION OF ATTACHED APPENDIX

Not Applicable

### BACKGROUND OF THE INVENTION

1. Field of the Invention

The disclosed relates to the field of rain harvesting and, more specifically, to a self-cleaning device that effectively filters debris and dirt from rainwater collected from a gutter system such that the clean water can be stored and re-used.

2. Description of Related Art

With the ever increasing demand on fresh water and the ever decreasing available supply, rain harvesting is becoming more and more popular. A search of the prior art reveals a host of patents and products pertaining to various rain gutter filtration systems, downspout filters, diverters, harvesters and more. The majority of these devices are targeted to residential home use and have limited filtration capability. In addition, very few are compatible with the standard oval gutter system typically found on homes and buildings. The known devices are designed for catching or filtering small to medium amounts of water. The known filtration systems are simplistic, as the end result water is often stored for a relatively short period of time, and then only used for limited purpose such as watering vegetation, for which purpose the water does not have to be particularly clean. Last, the devices are usually designed to be used near ground level and could not be adapted for use on a tall structure, such as on a commercial building or a barn.

U.S. Pat. No. 4,801,377 is a “Debris Separator Unit for Rain Gutter Downspouts” describing a steeply angled grating in the downspout of a gutter system to permit water to flow down through the downspout while leaves and debris are carried out a different opening. U.S. Pat. No. 5,302,283 is entitled “Leaf Guard and Strainer Assembly for a Gutter Downspout” and is designed to prevent the downspout from being clogged with leaves and debris while permitting water in the gutter to flow. U.S. Pat. No. 7,628,911 entitled “Rain Gutter Member” has an inlet operatively coupled to a gutter trough and an outlet configured to pass water to the downspout.

There is a need for a device that is compatible with conventional gutters, that can be used on tall buildings and that can render the harvested water clean enough that it can go into a high capacity storage tank for an extended period of time without turning to sludge or becoming foul.

The granted patents and published applications currently known do not achieve a sufficient enough level of cleaning for the water to then be stored for any length of time nor used for animal watering purposes. They also do not appear to be configured for use with a tall commercial or industrial type building.

### NOTATION AND NOMENCLATURE

Certain terms are used throughout the following description to refer to particular method components. As one skilled in the art will appreciate, design and manufacturing companies may refer to a component by different names. This document does not intend to distinguish between components that differ in name but not function.

In the following discussion, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other intermediate devices and connections. Moreover, the term “method” means “one or more components” combined together. Thus, a method can comprise an “entire method” or “sub methods” within the method.

### SUMMARY OF THE INVENTION

The disadvantages shown in the prior art are solved by a novel method and device for rain collection and filtration.

It is an objective of the disclosed to provide a plurality of water capture and filtration phases to ensure maximum debris removal.

It is an objective of the disclosed to enable use with a conventional oval gutter without the need for gutter modification.

It is an objective of the disclosed to provide a filtration system that cleans over 90 percent of the debris from rain or storm water, enabling longer term storage and more versatile use.

It is an objective of the disclosed to accommodate large volumes of rain or storm water, while efficiently and thoroughly removing debris.

It is an objective of the disclosed to accommodate use at the top of the building rather than near the ground, for more efficient use of space and to improve flows by natural gravity.

It is an objective to disclose a device that filters rainwater and is self cleaning of debris.

It is an objective to disclose a rain water filtration device having a plurality of vertically stacked chambers, each chamber in staggered succession and each chamber in fluid communication with at least one other chamber through a debris screen, the topmost chamber further having a receiving end in fluid communication with a rain gutter and the bottommost chamber further having an exit end capable of fluidly communicating with a storage container.

### BRIEF DESCRIPTION OF THE DRAWINGS

The drawings contained herein represent preferred embodiments of the invention and are not intended to limit the scope. For a detailed description of various embodiments, reference will now be made to the accompanying illustrative drawings in which:

FIG. 1 depicts a side view of the rain downspout filtration device, in accordance with the preferred embodiment.

FIG. 2 depicts a cutaway view of the rain downspout filtration device, showing the three debris screens, in accordance with the preferred embodiment.

FIG. 3 depicts a close up side view of the filtration device, in accordance with the preferred embodiment.

FIG. 4 depicts a close up view of the interior of one of the chambers.

FIG. 5 depicts a flowchart of the filtration phases.

### DETAILED DESCRIPTION OF THE PREFERRED EMBODIMENTS

The disclosed solves the problems described above and provides more comprehensive debris filtration than any of the known prior art. The disclosed invention further enables use with conventional oval gutters and can be used with a riser system, especially for tall buildings. The disclosed invention is designed to accommodate large volumes of water and to provide efficient and effective cleaning of the same, enabling long term storage of the water.

Debris in stored rainwater causes a host of problems. It clogs outlets and encourages the faster purification and decay of the water. Consequently, there are a variety of simplistic downspouts, diverters and filters on the market to prevent debris from entering collected rain or storm water storage containers. The simplistic devices capture larger particles of debris but are not thorough enough to achieve the level of filtration necessary for long term storage of water, nor do such simplistic devices ensure that the water is clean enough to be used as drinking water for animals, as opposed to merely using the stored water for agricultural use.

The disclosed method and device diverts and enables easy removal of over 90% of all dirt and debris that accompanies rainwater. The water that flows through the filtration device enters the storage container free of the vast majority of dirt, insects and debris. Consequently the water in the storage container may need only a small amount of bleach or purifier to stay clean for long periods of time. The water from the storage can consequently be used not only to water lawns but also to provide drinking water for animal consumption. This is an important accomplishment for rural dwellers who may depend on stored water to provide drinking water for livestock or pets during periods of electricity outage or other interference with well use. The disclosed device offers tremendous advantages in that it is also self-cleaning, such that rarely does the user need to manually clean accumulated debris from the device.

With reference to the attached figures, the disclosed is described below in detail.

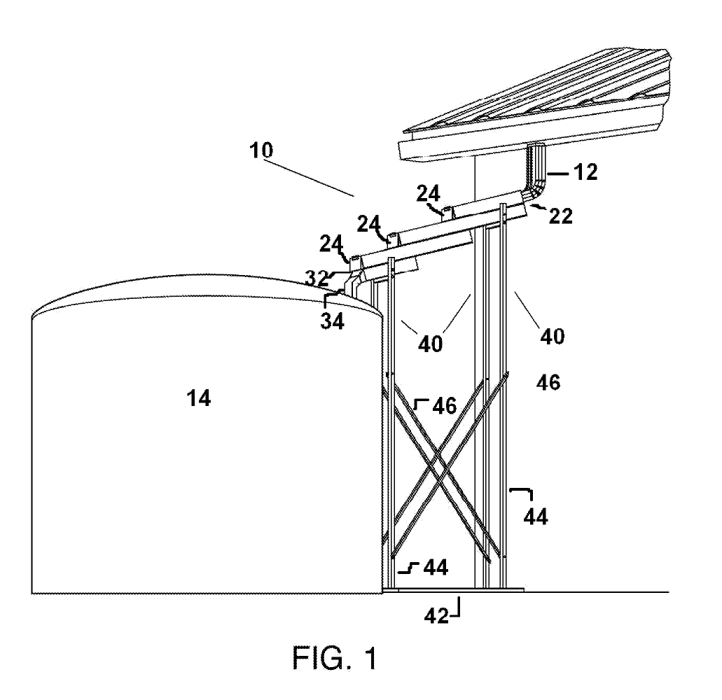

FIG. 1 illustrates a side view of the preferred embodiment of the filtration device 10 revealing four rectangular capture chambers which, in the preferred embodiment, achieve three phases of progressive filtration, by use of three debris screens, although there may be a varying number of chambers, phases or screens which could be of varying shapes depending upon the desired customization. In the preferred embodiment, as depicted in FIG. 1, the filtration device 10 is comprised of four connected chambers within which are found three progressively finer gauge debris screens or mesh that comprise the three phases of progressive filtration. The device is connected at one end to the existing roof gutter 12 system and can be connected at its opposite end to a storage container, such as a water storage tank 14, at the opposite end.

Each chamber is in communication with the next chamber, with the chambers being vertically stacked atop each other in a partially overlapping, staggered pattern and the whole device being installed at a slight downward angle or slope such that the water flow is assisted by gravity. In the drawings, the chambers are depicted as rectangular although other shapes may be contemplated.

In the preferred embodiment, the first chamber 20 is comprised of a top, a bottom, two opposing sides, a front end and a back end. The back end acts as a receiving end 22 which is in fluid communication with a rain gutter 12. The rainwater and accompanying debris, insects, dirt and leaves enters by gravity through the receiving end and travels by gravity down the length of the first chamber. The front end is comprised of an output 24 which may be a hinged swinging output door to enable excess debris to be pushed out by gravity induced water flow over time.

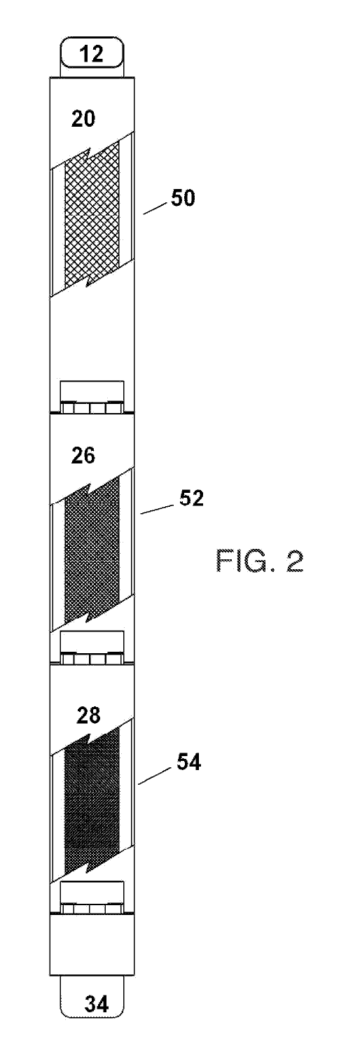

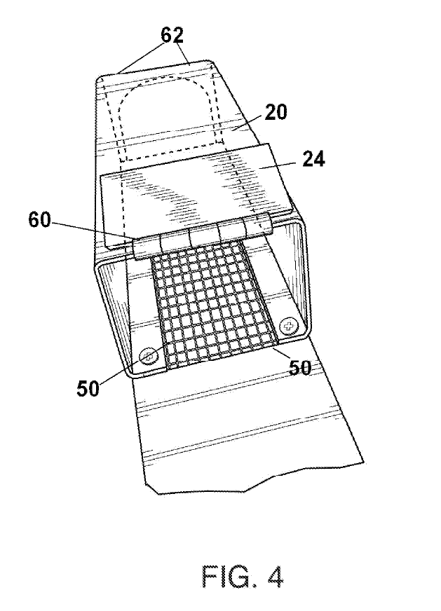

The bottom of the first chamber is comprised essentially of a horizontal debris screen (viewed in FIGS. 2 and 4) acting as a filter through which water falls through but large debris, such as small animals, leaves, large insects, sticks, rocks and other larger debris items are retained. Because of the novel concept of the staggering of the chambers, in congruence with the slope created, over time as the debris sits atop the debris screen, blocking the flow of water, the water flow builds and the water pressure ultimately pushes the blocking debris out through the swinging output door. Due to this feature, the user need not clean the device out on a regular basis. Once the water has pushed the debris out, the openings on the debris screen are once again cleared and successive paths of water free fall down through the debris screen into the next chamber.

The second chamber 26 is in a staggered position under the first chamber 20. At least a portion of the debris screen comprising the bottom of the first chamber 20 further comprises at least a portion of the top of the second chamber 26. This enables the two to be in fluid communication with each other such that the rain water free falls from the first chamber 20 down into the second chamber 26. In the preferred embodiment, the second chamber is also comprised of a top, a bottom, two opposing sides, a front end and a back end. As with the first chamber 20, the front end of the second chamber 26 comprises an output 24 which may be a hinged swinging output door. As with the first chamber 20, the bottom of the second chamber 26 is essentially comprised of a debris screen (viewed in FIG. 2). The debris screen of the second chamber is of a finer grade mesh (having smaller openings) than that of the first chamber. As a result, the second chamber retains debris of a smaller nature than that of the first chamber. The mechanism of the second chamber is the same as that of the first chamber in that as the openings of the debris screen are, over time, blocked by an accumulation of debris, the water builds up and extrudes the debris out the output. This action clears the openings of the debris screen allowing rainwater to resume its free fall into the subsequent chamber beneath the second chamber.

In a preferred embodiment, a third chamber 28 having the same characteristics as the second chamber 26, is staggered underneath the second chamber, such that at least a portion of the bottom of the second chamber serves as at least a portion of the top of the third chamber, such that the second and the third chamber are in fluid communication, allowing the rainwater to free fall from the second chamber into the third chamber. Similar to the first and the second chamber, the bottom of the third chamber 28 is comprised essentially of a debris screen. The debris screen of the third chamber is of a finer grade mesh (having smaller openings) than that of the second chamber. The mechanism of the third chamber is the same as that of the second chamber although it is retaining smaller debris which is ultimately washed out through the output 24 of the third chamber 28 in the same fashion as described in the paragraphs preceding.

The rain water, after having passed through the progressively finer debris screens of the first, second and third chambers, then free falls into the fourth chamber 30 which is in fluid communication with the third chamber 28, as at least a portion of the bottom of the third chamber 28 simultaneously serves as at least a portion of the top of the fourth chamber 40.

The fourth chamber is comprised of a top, a bottom, two opposing sides, a front end and a back end, wherein the front end is an exit end 32 in communication with a connector 34 that is further in fluid communication with a storage tank 14, such that the rain water in the fourth chamber 30 travels into the storage tank 14. In the preferred embodiment, the connector 34 is a downspout although other manners of connecting the device to the storage tank or reservoir may be contemplated.

Although the debris screen is described herein as a mesh it may be comprised of any type of filtering material that would allow the free fall of rainwater yet retain debris, provided the material is available in a range of grades, allowing for varying sizes of debris retention as described in the paragraphs above, in order that each successive chamber retains progressively smaller sized debris. It may be comprised of wire, nylon, plastic, fabric or other suitable materials. The mesh of each chamber may be of different composition if desired in order to achieve the different progressions of debris retention.

In the preferred embodiment, the output of each of the first three chambers is a hinged swinging door that can be opened from either direction, such that water can push the debris out through the door swinging outward, in a self-cleaning manner, or, if desired, the door can manually be swung open into the chamber for manual removal of debris if desired. Other types of outputs may be contemplated provided they achieve the functions and features described herein. In an embodiment, the debris screen itself could be removable, such as slide in, slide out, for purposes of maintenance, repair or replacement.

By the time the rainwater has passed through the three progressive finer debris screens found in the first three chambers, the water is over 90% free of dirt and debris and can pass into the storage reservoir in a clean state.

The construction of the chambers to one another in a staggered stacking manner enables the entire device to be mounted at a decline angle or downward slope. Although various method of mounting may be contemplated, including direct mounting to an exterior wall, provided the downward slope is achieved, the preferred embodiment for use on a tall building is the use of a riser. The chambers may be constructed of stainless steel, fiberglass, plastic, aluminum or other suitable materials that would withstand the effects of water and serve the purposes described herein.

Further illustrated in FIG. 1 is the riser 40 by which the device 10 is supported with a decline angle. The riser as depicted herein is comprised of a base 42, four vertical legs 44 and cross braces 46. The two vertical legs closest to the building are taller than the two vertical legs farther from the building (closer to the tank or reservoir). In the example prototype, the taller set of vertical legs was 84 inches in height and the shorter set of vertical legs was 69″ in height, creating a declining slope. This creates the downward slope of the device 10 enabling the gravitational flow of the water. It is important to have a slope that is small enough to maximize the free fall of the water down from chamber to chamber, yet significant enough to enable the self-cleaning mechanism whereby the water pushes the excess debris out through the output. The riser may be modified as needed depending up on the height needed and the slope desired.

FIG. 2 is a close up illustration of the progressively finer three debris screens that have been described in the preceding paragraphs. Visible at the bottom of the first chamber 20 is the first debris screen 50 which, in this depiction, is a wire mesh capable of trapping leaves and large debris. Visible at the bottom of the second chamber 26 is the second debris screen 52 which is a wire screen having smaller openings than the first debris screen, and is therefore capable of trapping medium sized debris that passed through the first debris screen along with the water. Visible at the bottom of the third chamber 28 is the third debris screen 54 which is a double nylon netting capable of trapping even smaller dimension debris that passed through both the first and second debris screen. The gutter 12 is visible at the receiving end of the first chamber 20. The connecting piece 34 is visible at the exit end 32 of the fourth chamber 30 which is not shown due to being underneath the third chamber 28.

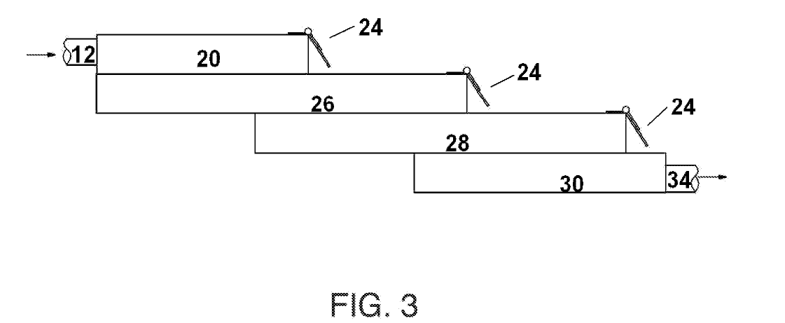

In FIG. 3 illustrates a close up side view of the device, showing the stacked staggered mounting, the gutter 12 connected to the first chamber 20, the output 24 doors and the connecting piece 34 at the exit end of the fourth chamber 30. Although the debris screens may be fixedly mounted, in an embodiment they may also be capable of sliding in and out of the chambers for purposes of maintenance, repair or replacement.

As the system is primarily designed to be used with a large storage container, such as a water storage tank, it is designed for the water to enter the system at the top of the container. As such, in the preferred embodiment, the device is supported by the riser to enable it to be coupled to the rain gutter near the roofline and travel straight into the container.

FIG. 4 reveals a closeup perspective view of the interior of the first chamber 20. Visible is the swinging hinge 60 construction of the output 24 door, the first debris screen 50 and the general rectangular shape. Also visible is a water deflector 62 which, in this example, is a U shaped piece that deflects the water as it enters the chamber, onto the path of the debris screen, rather than allowing the water to escape down the interior sides of the chamber. The water deflector can be constructed in different shapes and materials provided it achieves the stated purpose.

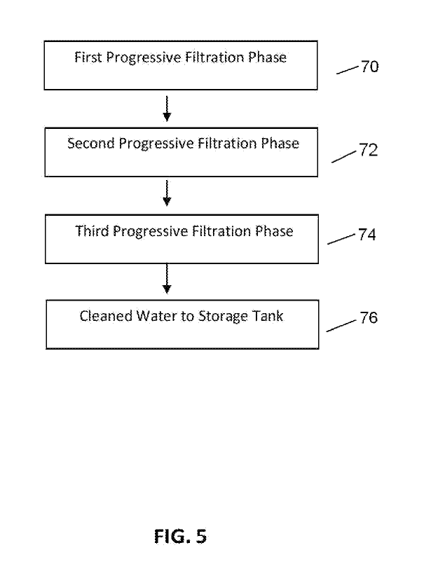

In practice, the rain water and accompanying debris travel down the existing roof gutter system and into the first chamber of the disclosed filtration device. As shown in FIG. 5, in the first chamber the water is subjected to the first progressive filtration phase 70 where the water travels down the slope of the chamber and then free falls down through the debris screen and into the second chamber. The large openings of the debris screen in the first chamber retain large debris such as small animals, leaves and other large debris. The rain water enters the second progressive filtration phase 72 where it flows down the slope of the second chamber and then free falls through the debris screen of the second chamber and into the third chamber, leaving the medium sized debris in the second chamber. The water then enters the third progressive phase 74 where it travels down the slope and free falls into the fourth chamber, leaving the small sized debris in the third chamber. The now clean water found in the fourth chamber travels to the storage tank. The remaining debris left in the first, second and third chambers is ultimately extruded out the swinging output door of each chamber by future rain water.

The disclosed device, system and method eliminates the disadvantages of the prior art and offers advantages heretofore unknown in rain collection and downspout filtration systems.

While the disclosed has been described in conjunction with the preferred embodiments thereof, many changes, modifications, alterations and variations will be apparent to those skilled in the art. The invention should therefore not be limited to the particular preferred embodiment disclosed but should include all embodiments that could fall within the scope of the claims.

Accordingly, the preferred embodiments of the invention shown in the drawings and described in detail above are intended to be illustrative, not limiting, and various changes may be made without departing from the spirit and scope of the invention as defined by the claims set forth below.

What is claimed is:

1. A rain water filtration device, the device comprising a plurality of vertically stacked chambers, each chamber in staggered succession to the other chambers and each chamber in fluid communication with at least one other chamber through a debris screen, the topmost chamber further having a receiving end in fluid communication with a rain gutter and the bottom most chamber further having an exit end capable of fluidly communicating with a storage tank.

2. The device of claim 1 wherein the device is mounted at a downward angle, such that a declining slope is created from the first chamber to the last chamber.

3. The device of claim 1 wherein, with the exception of the bottom most chamber, each debris screen forms at least a portion of the bottom of one chamber while simultaneously forming at least a portion of the top of the next chamber.

4. The device of claim 1 wherein one or more of the chambers further comprise a swinging output door.

5. The device of claim 1 wherein the debris screen slides in and out of the chamber.

6. The device of claim 1 wherein the device is mounted to a wall.

7. The device of claim 1 wherein a riser supports the system.

8. The device of claim 1 wherein each debris screen has progressively smaller openings than the debris screen superior to it.

9. The device of claim 1 wherein one or more chambers further comprise a water deflector.

10. A rain water filtration device, the device comprising a plurality of progressive filtration phases, each phase comprising a chamber housing having a debris screen, the chambers vertically connected to one another and in fluid communication to each other, the device further having a topmost chamber with a receiving end in fluid communication with a rain gutter and a bottom chamber having an exit end capable of fluidly communicating with a storage tank.

11. The device of claim 10 wherein the device is mounted at a downward angle, such that a declining slope is created from the first chamber to the last chamber.

12. The device of claim 10 wherein, with the exception of the bottom most chamber, each debris screen forms at least a portion of the bottom of one chamber while simultaneously forming at least a portion of the top of the next chamber.

13. The device of claim 10 wherein one or more of the chambers further comprise a swinging output door.

14. The device of claim 10 wherein the debris screen slides in and out of the chamber.

15. The device of claim 10 wherein the device is mounted to a wall.

16. The device of claim 10 wherein a riser supports the system.

17. The device of claim 10 wherein each debris screen has progressively smaller openings than the debris screen superior to it.

18. The device of claim 10 wherein one or more chambers further comprise a water deflector.
